(19) United States
(12) Patent Application Publication
(10) Pub. No.: US 2022/0301316 A1
(43) Pub. Date: Sep. 22, 2022

(54) DETECTION SYSTEM, CONTROL APPARATUS, DETECTION APPARATUS, AND DETECTION METHOD

(71) Applicant: NEC Corporation, Tokyo (JP)

(72) Inventors: Shinichi MORIMOTO, Tokyo (JP); Masanori Sekido, Tokyo (JP); Masaru Eto, Tokyo (JP); Kazumine Ogura, Tokyo (JP); Masayuki Ariyoshi, Tokyo (JP)

(73) Assignee: NEC Corporation, Tokyo (JP)

(21) Appl. No.: 17/692,423

(22) Filed: Mar. 11, 2022

(30) Foreign Application Priority Data
Mar. 19, 2021 (JP) 2021-045897

(51) Int. Cl. G06V 20/52; G01V 8/00

(52) U.S. Cl. CPC G06V 20/52; G01V 8/005; G06V 2201/05; G06V 2201/07

(57) ABSTRACT

To shorten a waiting time for a belongings inspection, the present invention provides a detection system 1 including a plurality of detection apparatuses 20 and a control apparatus 10. The control apparatus 10 includes a setting unit 11 that sets, for each of the detection apparatuses 20, at least one piece of pre-registered referrable data as reference data. The detection apparatus 20 includes an electromagnetic wave transmission/reception unit 22 that irradiates an electromagnetic wave having a wavelength of equal to or more than 30 micrometers and equal to or less than one meter and receives a reflection wave, and a detection unit 21 that performs, based on a signal of the reflection wave, detection processing based on the reference data being set for each of the detection apparatuses 20.

### TECHNICAL FIELD

The present invention relates to a detection system, a control apparatus, a detection apparatus, and a detection method.

### BACKGROUND ART

Patent Documents 1 and 2 disclose techniques that relate to the present invention.

Patent Document 1 (Japanese Patent Application Publication No. 2020-204513) discloses a technique for inspecting belongings by using a radio wave at least having a wavelength between one millimeter to 30 millimeters, and a technique for detecting a suspicious person carrying a dangerous object by a primary screening in which a large number of people are roughly inspected at once and performing a detailed inspection on the detected suspicious person by a secondary screening.

Patent Document 2 (Japanese Patent Application Publication No. 2002-008013) discloses a technique for processing an image generated by a CCD camera and thereby determining whether an appearance of a detection target object is good, and a technique for performing image processing with an inspection flow according to an inspection target type being input.

### Disclosure of the Invention

In order to ensure security and the like, a belongings inspection is performed at various places. It is desirable that a waiting time for the belongings inspection is shortened.

The present invention aims to shorten a waiting time for a belongings inspection by using an unconventional method.

According to the present invention,

a detection system including:

a plurality of detection apparatuses; and

a control apparatus, wherein

the control apparatus includes a setting means for setting, for each of the detection apparatuses, at least one piece of pre-registered referrable data as reference data,

the detection apparatus includes an electromagnetic wave transmission/reception means for irradiating an electromagnetic wave having a wavelength of equal to or more than 30 micrometers and equal to or less than one meter, and receiving a reflection wave, and

the control apparatus or the detection apparatus includes a detection means for performing, based on a signal of the reflection wave generated by each of the detection apparatuses, detection processing based on the reference data being set for each of the detection apparatuses is provided.

Further, according to the present invention,

a detection method including:

by a detection system including a plurality of detection apparatuses and a control apparatus,

setting, for each of the detection apparatuses, at least one piece of pre-registered referrable data as reference data;

irradiating an electromagnetic wave having a wavelength of equal to or more than 30 micrometers and equal to or less than one meter, and receiving a reflection wave; and

performing, based on a signal of the reflection wave generated by each of the detection apparatuses, detection processing based on the reference data being set for each of the detection apparatuses is provided.

Further, according to the present invention, a control apparatus included in the detection system is provided.

Further, according to the present invention, a detection apparatus included in the detection system is provided.

According to the present invention, a waiting time for a belongings inspection can be shortened.

### BRIEF DESCRIPTION OF THE DRAWINGS

FIG. 1 is a diagram illustrating one example of a functional block diagram of a detection system according to a first example embodiment.

FIG. 2 is a diagram illustrating one example of a hardware configuration of a control apparatus and a detection apparatus according to the first example embodiment.

FIG. 3 is a diagram illustrating one example of a functional block diagram of the detection system according to the first example embodiment.

FIG. 4 is a diagram schematically illustrating one example of an electromagnetic wave transmission/reception unit according to the first example embodiment.

FIG. 5 is a diagram schematically illustrating one example of information managed by the detection system according to the first example embodiment.

FIG. 6 is a diagram schematically illustrating one example of information managed by a detection system according to a second example embodiment.

FIG. 7 is a sequence diagram illustrating one example of a processing flow of the detection system according to the second example embodiment.

FIG. 8 is a diagram schematically illustrating one example of information managed by a detection system according to a third example embodiment.

FIG. 9 is a diagram schematically illustrating one example of the information managed by the detection system according to the third example embodiment.

FIG. 10 is a diagram schematically illustrating one example of the information managed by the detection system according to the third example embodiment.

FIG. 11 is a diagram schematically illustrating one example of the information managed by the detection system according to the third example embodiment.

FIG. 12 is a diagram schematically illustrating one example of the information managed by the detection system according to the third example embodiment.

FIG. 13 is a diagram schematically illustrating one example of the information managed by the detection system according to the third example embodiment.

FIG. 14 is a diagram illustrating one example of a functional block diagram of a detection system according to a fourth example embodiment.

FIG. 15 is a sequence diagram illustrating one example of a processing flow of the detection system according to the fourth example embodiment.

### DESCRIPTION OF EMBODIMENTS

In the following, example embodiments of the present invention are described with reference to the drawings. Note that, a similar component is denoted by a similar reference sign in all the drawings, and description thereof is omitted as appropriate.

### First Example Embodiment

### “Outline”

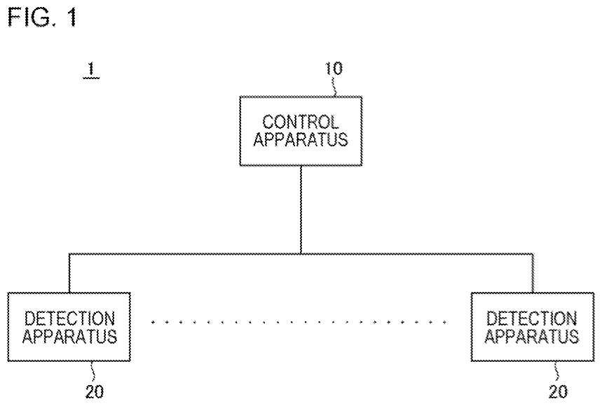

As illustrated in FIG. 1, a detection system 1 according to the present example embodiment includes a control apparatus 10 and a plurality of detection apparatuses 20. The detection system 1 according to the present example embodiment is used in any facility where a belongings inspection is needed. The facility is exemplified by a building, a company, an amusement facility, an airport, a station, and the like, but is not limited thereto.

In the present example embodiment, a plurality of the detection apparatuses 20 are installed in one facility, and a multi-step belongings inspection is performed on a visitor to the facility. For example, an example and the like where the detection apparatus 20 is installed at an entrance of the facility and the detection apparatus 20 is further installed at an entrance of each of a plurality of areas in the facility is conceivable.

Further, in the detection system 1 according to the present example embodiment, it is possible to set, for each of the detection apparatuses 20, at least one of pre-registered detectable target objects, as a detection target object. Specifically, the detection target object can be different for each detection apparatus 20. For example, detection target objects of a first detection apparatus 20 are “a gun and a knife”, and detection target objects of a second detection apparatus 20 are “a camera, a smartphone, and a mobile phone”.

Incidentally, there can be an object that cannot be brought into a facility, which is an “object that cannot be brought into any area of the facility” and an “object that cannot be brought into some areas of the facility but may be brought into the other areas of the facility”. In such a case, for example, when a centralized-type belongings inspection in which all of the “object that cannot be brought into any area of the facility” and the “object that cannot be brought into some areas of the facility but may be brought into the other areas of the facility” are detected is performed by the detection apparatus 20 installed at an entrance of the facility, a load of the belongings inspection on the detection apparatus 20 is increased, and a waiting time may also be increased.

On the other hand, for example, when a distributed-type belongings inspection in which the “object that cannot be brought into any area of the facility” is detected by the detection apparatus 20 installed at the entrance of the facility, and an “object that cannot be brought beyond a current location” among the “object that cannot be brought into some areas of the facility but may be brought into the other areas of the facility” is detected by the detection apparatus 20 installed at another location in the facility is performed, a load on each of the detection apparatuses 20 is reduced, and a waiting time for a belongings inspection at each of the detection apparatuses 20 can be shortened. According to the detection system 1 according to the present example embodiment, such a distributed-type belongings inspection is achieved.

Further, according to the detection system 1 according to the present example embodiment, it is possible to set a detection target object for each of the plurality of detection apparatuses 20 via the control apparatus 10 configured in such a way as to be communicable with each of the plurality of detection apparatuses 20. According to the detection system 1 described above, it is possible to set a detection target object for each of the plurality of detection apparatuses 20 from a location away from the detection apparatus 20. Work efficiency is improved in comparison to a case where a person goes to each location of the plurality of detection apparatuses 20 installed at various locations in the facility, directly operates each of the detection apparatuses 20, and thereby sets a detection target object for each of the detection apparatuses 20.

Further, according to the detection system 1 according to the present example embodiment, it is possible to set a detection target object for each of the detection apparatuses 20 through a simple operation of selecting at least one of pre-registered detectable target objects and setting the selected detectable target object as a detection target object. Since it is possible to set a detection target object for each of the detection apparatuses 20 by such a simple operation, a detection target object of each of the detection apparatuses 20 can be dynamically and appropriately adjusted according to a status of that day and time.

“Hardware Configuration”

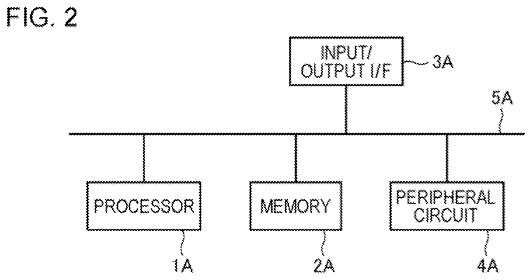

Next, one example of a hardware configuration of the control apparatus10 and the detection apparatus 20 will be described. FIG. 2 is a diagram illustrating a hardware configuration example of the control apparatus 10 and the detection apparatus 20. Each functional unit included in the control apparatus 10 and the detection apparatus 20 is achieved by any combination of a hardware and software, mainly a central processing unit (CPU) of any computer, a memory , a program loaded onto the memory, a storage unit such as a hard disk that stores the program (in addition to a program stored in advance since a shipping-stage, a program downloaded from a storage medium such as a compact disc (CD), a server on the Internet, and the like can also be stored), and an interface for network connection. Further, it is understood by a person skilled in the art that there are various modification examples of a method and an apparatus that achieve each functional unit.

As illustrated in FIG. 2, the control apparatus 10 and the detection apparatus 20 include a processor 1A, a memory 2A, an input/output interface 3A, a peripheral circuit 4A, and a bus 5A. The peripheral circuit 4A includes various modules. The control apparatus 10 and/or the detection apparatus 20 may not include the peripheral circuit 4A. Note that, the control apparatus 10 may be configured of a plurality of apparatuses that are physically and/or logically separated, or may be configured of a single apparatus that is physically and logically integrated.

Similarly, the detection apparatus 20 may be configured of a plurality of apparatuses that are physically and/or logically separated. In a case where a configuration is made by a plurality of apparatuses that are physically and/or logically separated, each of the plurality of apparatuses may be provided with the above-described hardware configuration.

The bus 5A is a data transmission path for the processor 1A, the memory 2A, the peripheral circuit 4A, and the input/output interface 3A to transmit/receive data to/from one another. The processor 1A is, for example, an arithmetic processing apparatus such a as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, an electromagnetic wave transmission/reception apparatus, and the like, an interface for outputting information to an output apparatus, an external apparatus, an external server, an electromagnetic wave transmission/reception apparatus, and the like, and the like. The input apparatus is, for example, a keyboard, a mouse, a microphone, and the like.

The output apparatus is, for example, a display, a speaker, a printer, a mailer, and the like. The processor 1A is capable of issuing an instruction for each module, and performing arithmetic operation, based on a result of operation of each module.

### “Functional Configuration”

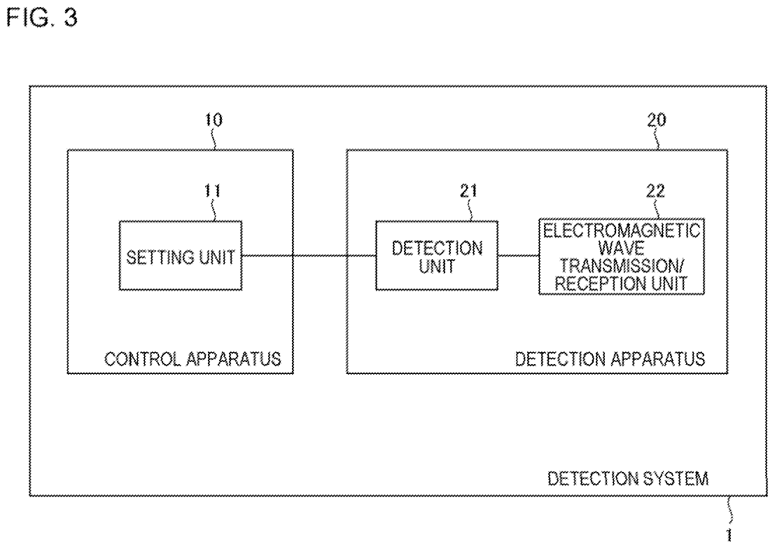

Next, a functional configuration of the detection system 1 will be described. One example of a functional block diagram of the detection system 1 is illustrated in FIG. 3. As illustrated, the detection system 1 includes the control apparatus 10 and a plurality of the detection apparatuses 20.

### “Functional Configuration of Detection Apparatus 20”

As illustrated in FIG. 3, each of the detection apparatuses 20 includes a detection unit 21 and an electromagnetic wave transmission/reception unit 22.

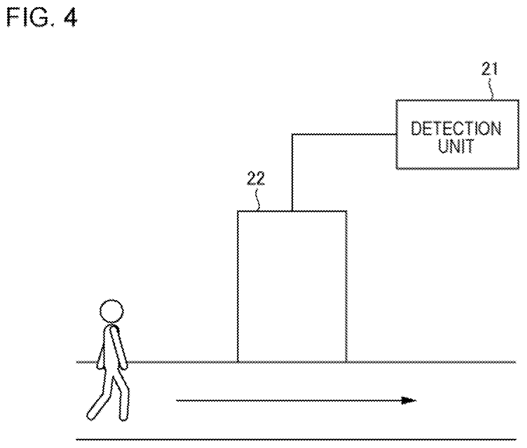

The electromagnetic wave transmission/reception unit 22 irradiates an electromagnetic wave having a wavelength of equal to or more than 30 micrometers and equal to or less than one meter (e.g., a microwave, a millimeter wave, a terahertz wave, and the like) toward a person present in a predetermined area, and receives a reflection wave. The electromagnetic wave transmission/reception unit 22 is, for example, a radar. The electromagnetic wave transmission/reception unit 22 can be configured by employing any technique. For example, the electromagnetic wave transmission/reception unit 22 may be a sensor panel configured of a radar with a plurality of antenna elements in line, as in an example in FIG. 4. Note that, the panel is one example, and the electromagnetic wave transmission/reception unit 22 may be configured by using another technique, such as a gate through which a person passes or a booth into which a person enters.

The detection unit 21 determines whether a person present in the predetermined area carries a preset detection target object, based on a signal of the reflection wave received by the electromagnetic wave transmission/reception unit 22. In the following, one example of determination processing will be described.

### First Processing Example

In the present example, the detection unit 21 generates a transmission image, based on a signal of a reflection wave received by the electromagnetic wave transmission/reception unit 22. Then, the detection unit 21 detects a detection target object from the transmission image, based on a shape of an object captured in the transmission image. When a detection target object is detected from the transmission image, it is determined that a person present in the predetermined area carries the detected detection target object.

Through prior preparation, a feature value of a shape of each of a plurality of objects is generated and is registered in the detection apparatus 20. An object of which a feature value of a shape is registered becomes a “detectable target object”. In the present example embodiment, at least one of a plurality of detectable target objects is set as a detection target object for each of the detection apparatuses 20 by a setting unit 11 described in the following.

The detection unit 21 detects the detection target object from the transmission image, based on a collation result of a feature value of a shape of the detection target object set in the own detection apparatus 20 and a feature value of a shape captured in the transmission image. Note that, an object among the detectable target objects that is not set as a detection target object is eliminated from a collation target. These pieces of processing performed by the detection unit 21 may be achieved by using an estimation model generated by machine learning based on training data configured of transmission images and labels of the plurality of objects, or may be achieved by template matching.

### Second Processing Example

In the present example, the detection unit 21 determines whether a person present in a predetermined area carries a preset detection target object, based on a feature value (reflection wave feature value) that appears in a signal of a reflection value received by the electromagnetic wave transmission/reception unit 22. When a reflection wave feature value being specific to the detection target object is detected from the signal of the reflection wave, it is determined that a person present in the predetermined area carries the detected detection target object.

Through prior preparation, a reflection wave feature value of each of a plurality of objects is generated and is registered in the detection apparatus 20. An object of which a reflection wave feature value is registered becomes a “detectable target object”. In the present example embodiment, at least one of a plurality of detectable target objects is set as a detection target object for each of the detection apparatuses 20 by the setting unit 11 described in the following.

The detection unit 21 detects, from a signal of a reflection wave, a reflection wave feature value being specific to the detection target object, based on a collation result of a reflection wave feature value of the detection target object set in the own detection apparatus 20 and a feature value that appears in the signal of the reflection wave. Note that, an object among the detectable target objects that is not set as a detection target object is eliminated from a collation target. These pieces of processing performed by the detection unit 21 may be achieved by using an estimation model generated by machine learning based on training data configured of signals of reflection waves and labels of the plurality of objects, or may be achieved by template matching.

The detection unit 21 is capable of outputting a detection result via a predetermined output apparatus (a display, a speaker, a warning lamp, a projection apparatus, and the like). For example, the output apparatus may be installed in a vicinity of each of the detection apparatuses 20, and may present predetermined information to a person to be inspected or a manager who manages an inspection. Further, the detection unit 21 may differ an output method of the output apparatus according to a content of the detection result (whether the detection target object is detected). There are various output methods, and any means may be employed in the present example embodiment.

“Functional Configuration of Control Apparatus 10”

As illustrated in FIG. 3, the control apparatus 10 includes the setting unit 11. In the present example embodiment, the control apparatus 10 and each of the plurality of detection apparatuses 20 are configured in such a way as to be remotely connectable. The control apparatus 10 according to the present example embodiment is, for example, a personal computer, a smartphone, a tablet terminal, a mobile phone, and the like, but is not limited thereto. A user performs a predetermined operation on the control apparatus 10, and thereby connects the control apparatus 10 and each of the plurality of detection apparatuses 20 individually.

The setting unit 11 sets, for each of the detection apparatuses 20, at least one piece of pre-registered referable data as reference data. In the present example embodiment, the setting unit 11 sets at least one of feature values (a feature value of a shape or a reflection wave feature value) of pre-registered detectable target objects as reference data. Through this setting, at least one of the pre-registered detectable target objects is set as a detection target object.

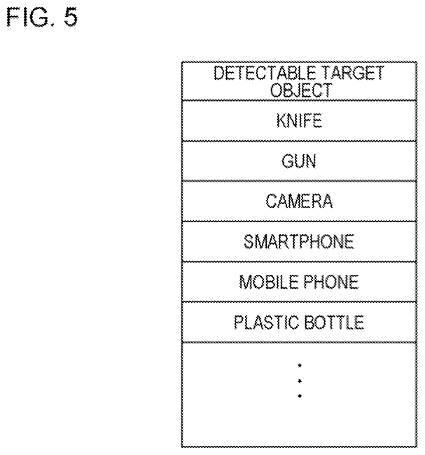

As described above, in the present example embodiment, through prior preparation, a feature value (a feature value of a shape or a reflection wave feature value) of each of the plurality of objects is generated and is registered in the detection apparatus 20. An object of which a feature value is registered becomes a “detectable target object”. The setting unit 11 accepts a user input that selects, for each of the detection apparatuses 20, at least one of the plurality of detectable target objects and that sets the selected detectable target object as a detection target object. For example, the setting unit 11 outputs a list of the detectable target objects as illustrated in FIG. 5, and accepts a user input that selects at least one of the detectable target objects from the list. Further, the setting unit 11 transmits, to the detection apparatus 20, information indicating a detection target object selected by the user input, and sets the detection target object in the detection apparatus 20.

### “Advantageous Effect”

According to the detection system 1 according to the present example embodiment, which includes the plurality of detection apparatuses 20 and is capable of setting a detection target object for each of the detection apparatuses 20, a distributed-type belongings inspection in which a detection target object is different for each of the detection apparatuses 20 is achieved.

As a result, a load on each of the detection apparatuses 20 is reduced, and a waiting time for the belongings inspection at each of the detection apparatuses 20 can be shortened.

Further, according to the detection system 1 according to the present example embodiment, it is possible to set a detection target object for each of the plurality of detection apparatuses 20 via the control apparatus 10 configured in such a way as to be communicable with each of the plurality of detection apparatuses 20. According to the detection system 1 described above, it is possible to set a detection target object for each of the plurality of detection apparatuses 20 from a location away from the detection apparatus 20. Work efficiency is improved in comparison to a case where a person goes to each location of the plurality of detection apparatuses 20 installed at various locations in the facility, directly operates each of the detection apparatuses 20, and thereby sets a detection target object for each of the detection apparatuses 20.

Further, according to the detection system 1 according to the present example embodiment, it is possible to set a detection target object for each of the detection apparatuses 20 through a simple operation of selecting at least one of the pre-registered detectable target objects and setting the selected detectable target object as a detection target object. Since it is possible to set a detection target object for each of the detection apparatuses 20 by such a simple operation, a detection target object of each of the detection apparatuses 20 can be dynamically and appropriately adjusted according to a status of that day and time.

### Second Example Embodiment

A detection system 1 according to the present example embodiment is different from that of the first example embodiment in that a control apparatus 10 is a server and a setting of a detection target object of each of a plurality of detection apparatuses 20 is managed by the server. In the following, a detailed description thereof will be made.

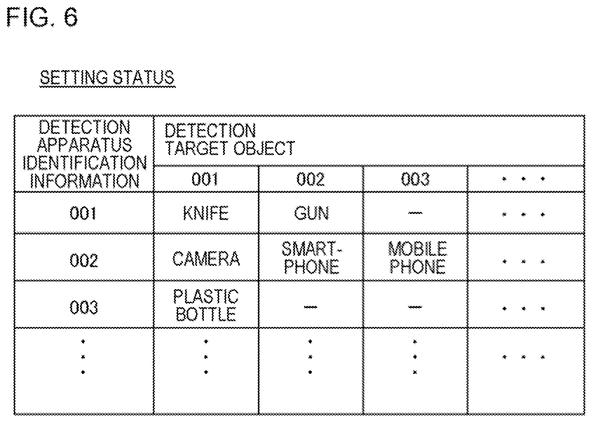

A setting unit 11 accepts a user input that selects, for each of the detection apparatuses 20, at least one of a plurality of detectable target objects and that sets the selected detectable target object as a detection target object. As illustrated in FIG. 6, the setting unit 11 is capable of collectively managing setting statuses of the detection target objects of the plurality of detection apparatuses 20. Further, the setting unit 11 transmits, to each of the detection apparatuses 20, information indicating a detection target object selected by the user input, based on the setting status managed in such a way, and sets a detection target object in each of the detection apparatuses 20.

Note that, the setting unit 11 may output, to a user, information as illustrated in FIG. 6 that collectively indicates setting statuses of detection target objects of the plurality of detection apparatuses 20. In this way, a user can collectively recognize the setting statuses of the detection target objects of the plurality of detection apparatuses 20, based on the information, and can easily recognize duplicated inspections, an inspection omission, and the like.

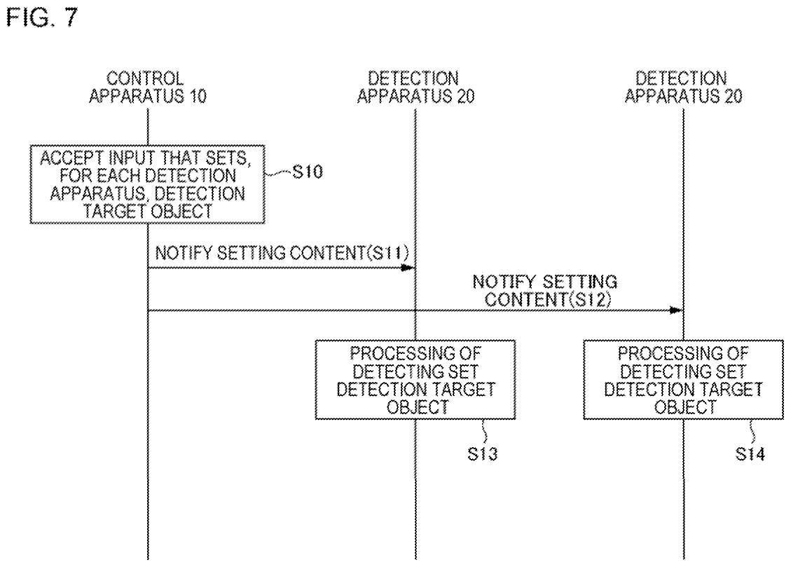

One example of a processing flow of the detection system 1 is described by using a sequence diagram in FIG. 7. First, the control apparatus 10 accepts a user input that selects, for each of the plurality of detection apparatuses 20, at least one of a plurality of detectable target objects and that sets the selected detectable target object as a detection target object (S10). After that, the control apparatus 10 transmits information indicating the set detection target object to each of the plurality of detection apparatuses 20, and sets the detection target object in each of the detection apparatuses 20 (S11, S12). After that, each of the detection apparatuses 20 executes processing of detecting the set detection target object (S13, S14).

Other parts of the configuration of the detection system 1 according to the present example embodiment are similar to those of the first example embodiment.

According to the detection system 1 according to the present example embodiment, an advantageous effect similar to the first example embodiment is achieved. Further, according to the detection system 1 according to the present example embodiment, it is possible that settings of the detection target objects of the plurality of detection apparatuses 20 are collectively managed by the server. Therefore, it is made easier to manage the settings of the detection target objects of the plurality of detection apparatuses 20, and it is also made easier to collectively recognize setting statuses and the like of the detection target objects of the plurality of detection apparatuses 20.

### Third Example Embodiment

A detection system 1 according to the present example embodiment is different from that of the second example embodiment in that setting information specifying a detection target object of each detection apparatus 20 when each condition is satisfied is registered for each condition, and that it is possible to set a detection target object for each detection apparatus 20, based on the setting information. In the following, a detailed description thereof will be made.

Based on a user input, a setting unit 11 registers, for each condition, setting information specifying a detection target object of each detection apparatus 20 when each condition is satisfied. Further, the setting unit 11 sets a detection target object for each detection apparatus 20, based on the setting information.

Note that, the setting unit 11 may survey whether the condition is satisfied, and instruct, based on a surveillance result, each of the detection apparatuses 20 to change the detection target object. As another example, the setting unit 11 may preliminarily transmits the setting information to each of the detection apparatuses 20 and set a detection target object for each condition indicated by the setting information. In this case, each of the detection apparatuses 20 surveys whether the condition is satisfied, and changes, based on a surveillance result, the detection target object being set in an own apparatus. Means for acquiring material data for determining whether the condition is satisfied is not specifically limited, and may be achieved by using any technique.

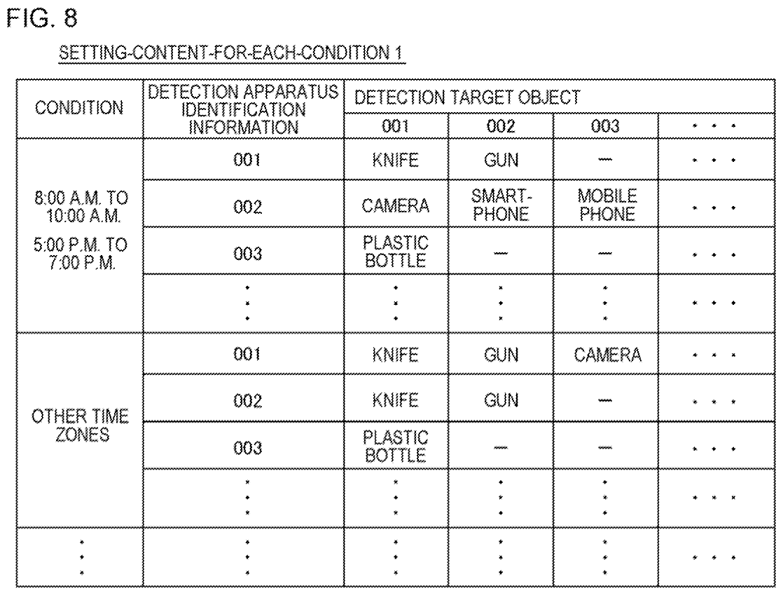

The condition is defined by using at least either a date and time or a day of week, for example. FIG. 8 schematically illustrates one example of setting information (setting contents for each condition) where the condition is defined in terms of time. In the illustrated example, a detection target object that is set for each of the detection apparatuses 20 from 8:00 a.m. to 10:00 a.m. and from 5:00 p.m. to 7:00 p.m. and a detection target object that is set for each of the detection apparatuses 20 during other time zones are exemplified.

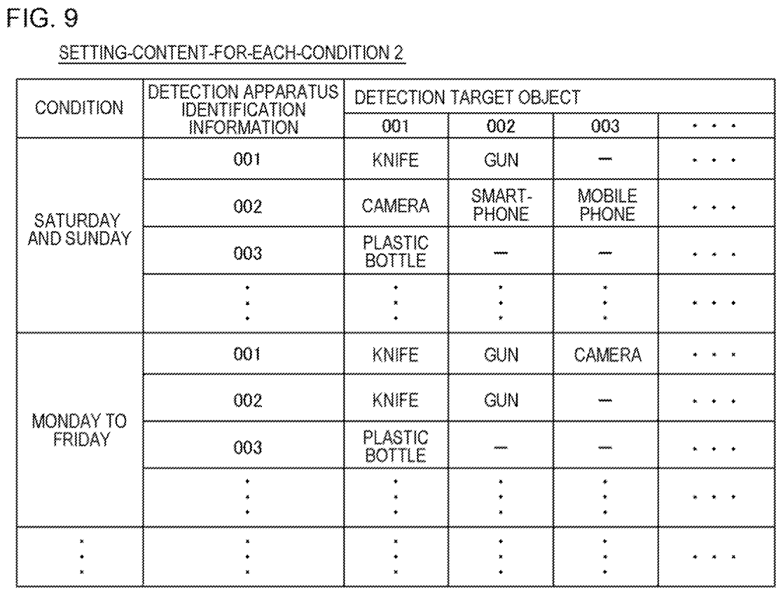

FIG. 9 schematically illustrates one example of setting information (setting contents for each condition) where the condition is defined in terms of day of week. In the illustrated example, a detection target object that is set for each of the detection apparatuses 20 on Saturday and Sunday and a detection target object that is set for each of the detection apparatuses 20 during other days of week are exemplified.

Although an example where the condition is defined in terms of date is not illustrated, it is possible to categorize cases by date, such as from February 1 to 15, 2021, after Feb. 15, 2021, and the like, and specify a detection target object of each of the detection apparatuses 20 according to each of the cases.

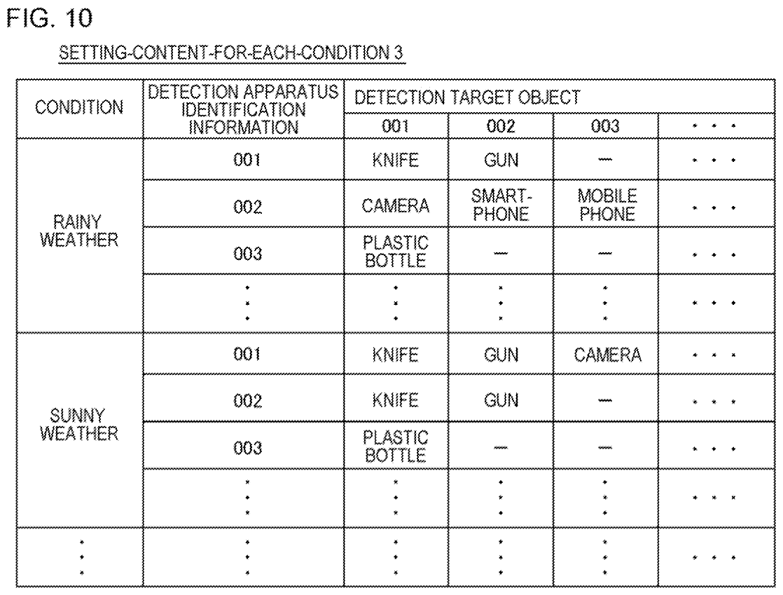

Otherwise, the condition may be defined by using at least either a weather or an air temperature. FIG. 10 schematically illustrates one example of setting information (setting contents for each condition) where the condition is defined in terms of weather. In the illustrated example, a detection target object that is set for each of the detection apparatuses 20 when it is rainy and a detection target object that is set for each of the detection apparatuses 20 when it is sunny are exemplified.

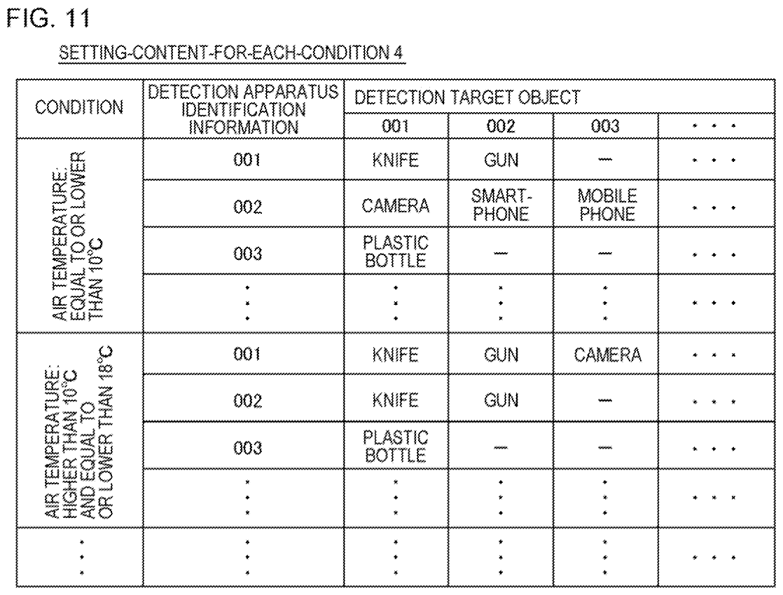

FIG. 11 schematically illustrates one example of setting information (setting contents for each condition) where the condition is defined in terms of air temperature. In the illustrated example, a detection target object that is set for each of the detection apparatuses 20 when an air temperature is equal to or lower than 10° C. and a detection target object that is set for each of the detection apparatuses 20 when the air temperature is higher than 10° C. and is equal to or lower than 18° C. are exemplified.

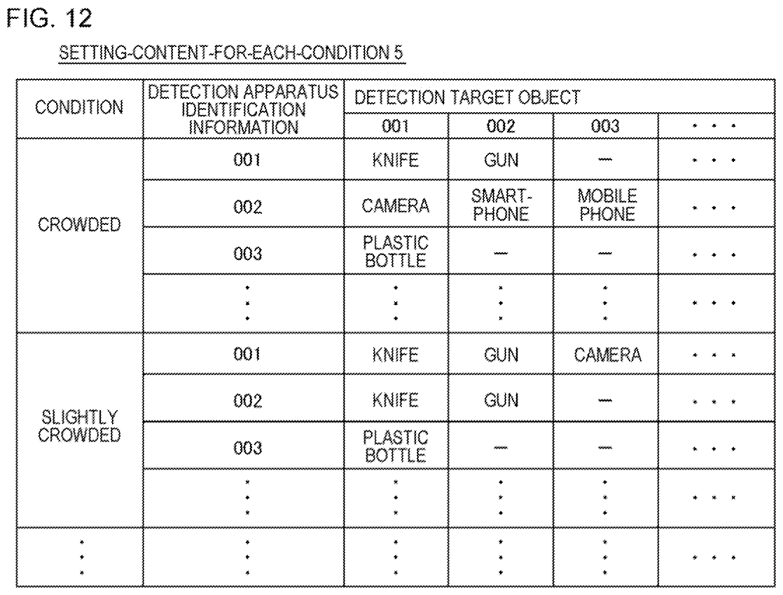

Otherwise, the condition may be defined by using a congestion status of a facility where the plurality of detection apparatuses 20 are installed. FIG. 12 schematically illustrates one example of setting information (setting contents for each condition) where the condition is defined in terms of congestion status. In the illustrated example, a detection target object that is set for each of the detection apparatuses 20 when the facility is crowded and a detection target object that is set for each of the detection apparatuses 20 when the facility is slightly crowded are exemplified. Note that, the congestion status of a facility may be determined based on the number of visitors determined by any means such as an image analysis and the like.

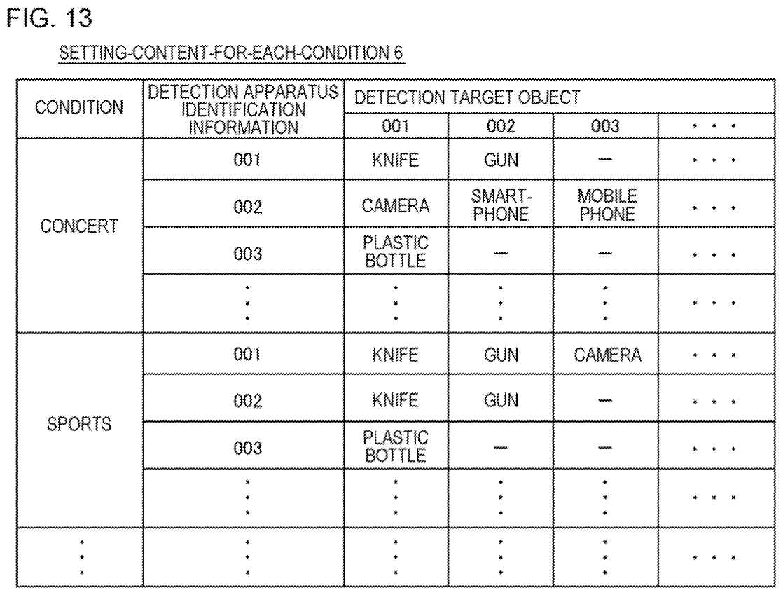

Otherwise, the condition may be defined by using a content of an event performed in a facility where the plurality of detection apparatuses 20 is installed. FIG. 13 schematically illustrates one example of setting information (setting contents for each condition) defined by using a content of an event. In the illustrated example, a detection target object that is set for each of the detection apparatuses 20 when a concert is performed and a detection target object that is set for each of the detection apparatuses 20 when a sports event is performed are exemplified. Note that, a content of event performed at each timing is determined based on a user input.

Note that, although it is not illustrated, the categorization of cases may be performed by using another item, and a detection target object of each of the detection apparatuses 20 may be specified according to each of the cases. Further, the categorization of cases may be performed by combining several of such items as a date and time, a day of a week, a weather, an air temperature, a congestion status of a facility, a content of an event performed in the facility, and another item, and a detection target object of each of the detection apparatuses 20 may be specified according to each of the cases.

Other parts of the configuration of the control apparatus 10 are similar to those of the second example embodiment.

According to the detection system 1 according to the present example embodiment, an advantageous effect similar to the second example embodiment is achieved. Further, according 2 5 to the detection system 1 according to the present example embodiment, it is possible to register, for each condition, setting information specifying a detection target object of each of the detection apparatuses 20 when each condition is satisfied, and set a detection target object for each of the detection apparatuses 20, based on the setting information. According to the detection system 1 described above, a user can avoid a troublesome operation on the control apparatus 10 of changing a detection target object of each of the detection apparatuses 20 every time a change of detection target object is necessary.

### Fourth Example Embodiment

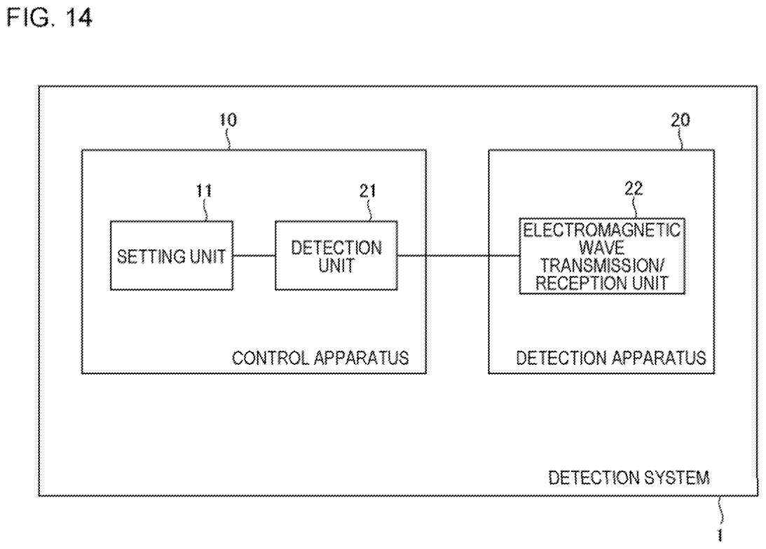

As illustrated in a functional block diagram in FIG. 14, a detection system 1 according to the present example embodiment is different from that of the first to third example embodiments in that a control apparatus 10 includes a detection unit 21.

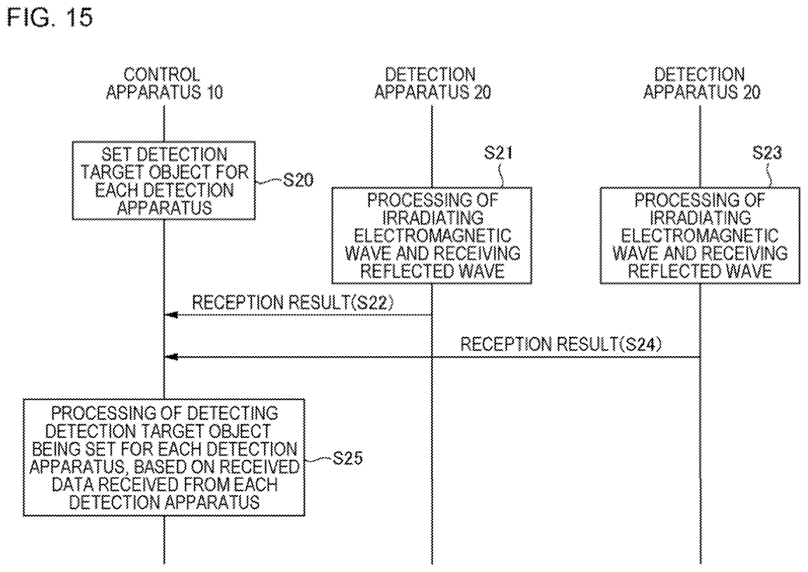

One example of a processing flow of the detection system 1 is described by using a sequence diagram in FIG. 15. First, the control apparatus 10 accepts a user input that selects, for each detection apparatus 20, at least one of a plurality of detectable target object and that sets the selected detectable target object as a detection target object. Further, the control apparatus 10 sets a detection target object for each detection apparatus 20 according to the user input (S20). A content of the setting is registered in the control apparatus10.

Each detection apparatus 20 executes processing of irradiating an electromagnetic wave having a wavelength of equal to or more than 30 micrometers and equal to or less than one meter and receiving a reflection wave (S21, S23). Further, each detection apparatus 20 transmits a reception result to the control apparatus 10 (S22, S24). S22 and S24 may be performed in real-time processing, or may be performed in batch processing. The reception result to be transmitted in S22 and S24 may be a signal of the reflection wave itself received by an electromagnetic wave transmission/reception unit 22, or may be a transmission image generated based on the signal of the reflection wave.

After that, based on the reception result received from each detection apparatus 20, the control apparatus 10 performs processing of detecting the detection target object being set for each detection apparatus 20 (S25).

Other parts of the configuration of the detection system 1 according to the present example embodiment are similar to those of the first to third example embodiments.

According to the detection system 1 according to the present example embodiment, an advantageous effect similar to the first to third example embodiments is achieved.

### <Application Example of Multi-Stage Configuration>

Herein, an application example of a multi-stage configuration achieved by a detection system 1 will be described.

For example, it is possible to set a dangerous object as a detection target object at a reception of a company building, and set a camera, a smartphone, a mobile phone, and the like as detection target objects at an entrance of a security area in the company building.

In addition, it is possible to set a dangerous object as a detection target object at an entrance of a theme park, and set a plastic bottle and the like as detection target objects at an entrance of an attraction in the theme park.

In addition, it is possible to set a relatively large number of detection target objects for a detection apparatus 20 installed in an uncrowded location, and set a relatively small number of detection target objects for the detection apparatus 20 installed in a crowded location.

In addition, it is possible to set, for the detection apparatus 20 installed in a hall or a stadium, an appropriate detection target object according to an event being performed at that time. For example, it is possible to set a camera as a detection target object when an exhibition is being performed, and set a plastic bottle or a musical instrument as a detection target object when a sporting event is being performed.

### MODIFICATION EXAMPLE 1

In the above-described example embodiment, a “setting unit 11 that sets, for each detection apparatus 20, at least one piece of pre-registered referrable data as reference data” sets a feature value (a feature value of a shape or a reflection wave feature value) of a detection target object as the reference data. Specifically, the setting unit 11 sets abnormal data (data of a target object being prohibited to be brought in), which is not desirable to be included, as the reference data. Further, the detection unit 21 executes processing of detecting, from a signal of a reflection wave, the abnormal data being set as the reference data.

In the present modification example, the setting unit 11 sets normal data, which is desirable to be included, as reference data. Specifically, the setting unit 11 sets at least one of a plurality of pieces of pre-registered normal data (referrable data) as the reference data. Further, the detection unit 21 performs, based on the normal data, processing of detecting an abnormal state (a state that is different from a state indicated by the normal data) from a signal of a reflection wave. Also in such a modification example, an advantageous effect similar to the above-described example embodiment is achieved.

### MODIFICATION EXAMPLE 2

In the above-described example embodiment, a target object being prohibited to be brought in is set as a detection target object. In the present modification example, a target object that a user is required to carry is set as a detection target object. For example, a badge of a police officer, an object that a person participating in an event is required to carry, and the like are detection target objects in the present modification example. Further, in the present modification example, a user whose detection target object is detected is allowed to pass and a user whose detection target object is not detected is not allowed to pass.

Note that, the target object being prohibited to be brought in may be set as a first detection target object, and the target object that a user is required to carry may be set as a second detection target object. In this case, detection results are categorized into a plurality of cases, which are “a case where the first detection target object is detected and the second detection target object is not detected”, “a case where the second detection target object is detected and the first detection target object is not detected”, “a case where both the first detection target object and the second detection target object are detected”, “a case where both the first detection target object and the second detection target object are not detected”, and the like. What processing is to be performed for a user in each of the cases is a design matter.

Note that, in the present description, “acquisition” includes at least one of “fetching data stored in another apparatus or a storage medium by an own apparatus (active acquisition)”, based on a user input, or based on a program instruction, for example, requesting or inquiring another apparatus and receiving, accessing to another apparatus or a storage medium and reading, and the like, “inputting data to be output from another apparatus to an own apparatus (passive acquisition)”, based on a user input, or based on a program instruction, for example, receiving data to be distributed (or transmitted, push-notified, or the like), and acquiring by selecting from among received data or received information, and “generating new data by editing data (converting into a text, rearranging data, extracting a part of pieces of data, changing a file format, and the like) and the like, and acquiring the new data”.

A part or the whole of the above-described example embodiments may also be described as the following supplementary notes, but is not limited thereto.
1. A detection system including:

a plurality of detection apparatuses; and

a control apparatus, wherein

the control apparatus includes a setting means for setting, for each of the detection apparatuses, at least one piece of pre-registered referrable data as reference data,

the detection apparatus includes an electromagnetic wave transmission/reception means for irradiating an electromagnetic wave having a wavelength of equal to or more than 30 micrometers and equal to or less than one meter, and receiving a reflection wave, and

the control apparatus or the detection apparatus includes a detection means for performing, based on a signal of the reflection wave generated by each of the detection apparatuses, detection processing based on the reference data being set for each of the detection apparatuses.
2. The detection system according to supplementary note 1, wherein the setting means accepts a user input specifying the detection apparatus and the reference data, and sets the reference data for each of the detection apparatuses, based on the user input.
3. The detection system according to supplementary note 1, wherein

the setting means sets the reference data for each of the detection apparatuses, based on setting information specifying, for each condition, the reference data of each of the detection apparatuses when the condition is satisfied.
4. The detection system according to supplementary note 3, wherein the condition is defined by using at least either one of a date and time and a day of week.
5. The detection system according to supplementary note 3 or 4, wherein the condition is defined by using at least either one of a weather and an air temperature.
6. The detection system according to any one of supplementary notes 3 to 5, wherein the condition is defined by using a congestion status of a facility where the plurality of detection apparatuses are installed.
7. The detection system according to any one of supplementary notes 3 to 6, wherein the condition is defined by using a content of an event being performed at that time in a facility where the plurality of detection apparatuses are installed.
8. A detection method including:

by a detection system including a plurality of detection apparatuses and a control apparatus,

setting, for each of the detection apparatuses, at least one piece of pre-registered referrable data as reference data;

irradiating an electromagnetic wave having a wavelength of equal to or more than 30 micrometers and equal to or less than one meter, and receiving a reflection wave; and

performing, based on a signal of the reflection wave generated by each of the detection apparatuses, detection processing based on the reference data being set for each of the detection apparatuses.
9. A control apparatus included in the detection system according to any one of supplementary notes 1 to 7.
10. A detection apparatus included in the detection system according to any one of supplementary notes 1 to 7.
1 Detection system
10 Control apparatus
11 Setting unit
20 Detection apparatus
21 Detection unit
22 Electromagnetic wave transmission/reception unit
1A Processor
2A Memory
3A Input/output interface (I/F)
4A Peripheral circuit
5A Bus

1. A detection system comprising:
a plurality of detection apparatuses; and
a control apparatus, wherein
the control apparatus sets, for each of the detection apparatuses, at least one piece of pre-registered referrable data as reference data,
the detection apparatus irradiates an electromagnetic wave having a wavelength of equal to or more than 30 micrometers and equal to or less than one meter, and receives a reflection wave, and
the control apparatus or the detection apparatus-performs, based on a signal of the reflection wave generated by each of the detection apparatuses, detection processing based on the reference data being set for each of the detection apparatuses.

2. The detection system according to claim 1, wherein
the control apparatus accepts a user input specifying the detection apparatus and the reference data, and sets the reference data for each of the detection apparatuses, based on the user input.

3. The detection system according to claim 1, wherein
the control apparatus sets the reference data for each of the detection apparatuses, based on setting information specifying, for each condition, the reference data of each of the detection apparatuses when the condition is satisfied.

4. The detection system according to claim 3, wherein
the condition is defined by using at least either one of a date and time and a day of week.

5. The detection system according to claim 3, wherein
the condition is defined by using at least either one of a weather and an air temperature.

6. The detection system according to claim 3, wherein
the condition is defined by using a congestion status of a facility where the plurality of detection apparatuses are installed.

7. The detection system according to claim 3, wherein
the condition is defined by using a content of an event being performed at that time in a facility where the plurality of detection apparatuses are installed.

8. A detection method comprising:
by a detection system including a plurality of detection apparatuses and a control apparatus,
setting, for each of the detection apparatuses, at least one piece of pre-registered referrable data as reference data;
irradiating an electromagnetic wave having a wavelength of equal to or more than 30 micrometers and equal to or less than one meter, and receiving a reflection wave; and
performing, based on a signal of the reflection wave generated by each of the detection apparatuses, detection processing based on the reference data being set for each of the detection apparatuses.

9. A control apparatus included in the detection system according to claim 1.
